(19) United States
(12) Patent Application Publication
(10) Pub. No.: US 2008/0094789 A1
(43) Pub. Date: Apr. 24, 2008

(54) FLAT PANEL DISPLAY

(76) Inventor: Young Jae Lee, Seongnam-Si (KR)

Correspondence Address: F. CHAU & ASSOCIATES, LLC, 130 WOODBURY ROAD, WOODBURY, NY, 11797, US

(21) Appl. No.: 11/838,983

(22) Filed: Aug. 15, 2007

(30) Foreign Application Priority Data
Aug. 16, 2006 (KR) 10-2006-0076958

(51) Int. Cl. G06F 1/16

(52) U.S. Cl. 361/681

(57) ABSTRACT

A flat panel display having a coupling structure for coupling a flat panel display module to a case. The flat panel display comprises a flat panel display module having a plurality of protrusions formed on two opposite sides, and a first case for receiving the flat panel display module. The first case includes a receiving portion providing a predetermined space in which the flat panel display module is seated, a fixing portion for fixing an end of the flat panel display module, and a plurality of coupling portions to be coupled with the plurality of protrusions. The fixing portion is made of an elastic member.

### CROSS-REFERENCE TO RELATED APPLICATION

The present application claims priority to Korean Patent Application No. 2006-0076958 filed on Aug. 16, 2006, the contents of which are incorporated herein by reference in their entirety.

### BACKGROUND OF THE INVENTION

1. Technical Field

The present invention relates to a flat panel display, and more particularly, to a flat panel display having a coupling structure for coupling a case and a flat panel display module such as a liquid crystal display module.

2. Discussion of the Prior Art

Among flat panel displays, a liquid crystal display (LCD) is widely used due to its characteristics such as lightweight, slim configuration, low power consumption, full color, and high resolution. LCDs have been used in connection with, for example, computers, notebooks, PDAs, phones, TVs, and audio/video equipment. An LCD can control light transmissivity according to image signals applied to a plurality of control switches arranged in a matrix to display a desired image on an LCD panel. LCDs have increased in size according to the demand of users, and an LCD module and a case for receiving the LCD module have also correspondingly increased in size. Thus, research has been conducted for a coupling structure of the larger-sized LCD module and the case and a lay-out of components of the LCD module, while maintaining a light weight, and a thin profile.

FIG. 1 is a schematic exploded perspective view showing a conventional LCD having a structure employing screws.

Referring to FIG. 1, the LCD includes an LCD module 30 for displaying an image, and a front case (not shown) and a rear case 40 for covering the LCD module. A top-mounting method is used for mounting the LCD module 30 to the rear case 40. Specifically, first to fourth mounting portions 11, 12, 13 and 14 having first to fourth screw holes 11a, 12a, 13a and 14a respectively formed therein are formed at four corners of a top chassis 10 of the LCD module to protrude by a predetermined distance. First to fourth screwing portions 41, 42, 43 and 44 corresponding to the first to fourth screw holes 11a, 12a, 13a and 14a are formed at four corners of the rear case 40 corresponding to the first to fourth mounting portions 11, 12, 13 and 14. The first to fourth screw holes 11a, 12a, 13a and 14a of the top chassis correspond to the first to fourth screwing portions 41, 42, 43 and 44 of the rear case 40, and first to fourth screws 11b, 12b, 13b and 14b penetrate the first to fourth screw holes 11a, 12a, 13a and 14a and are then coupled to the first to fourth screwing portions 41, 42, 43 and 44, thereby fixing the LCD module 30 to the rear case 40.

However, since the LCD module and the rear case are coupled using the screws, the number of processes for assembling the LCD is increased, thereby lowering assembling efficiency and productivity. In addition, since parts such as screws for coupling the LCD module and the rear case are additionally used, a manufacturing cost of the LCD is increased. Also, the mounting portions extending outward from a sidewall of the top chassis causes a size of the LCD to be increased.

### SUMMARY OF THE INVENTION

Embodiments of the present invention provide a flat panel display having a coupling structure for a flat panel display module and a case, which results in less processes required for assembling the flat panel display, less parts used for coupling the flat panel display module and the case, and allows for a slim structure of the flat panel display.

According to an embodiment of the present invention, a flat panel display comprises a flat panel display module having a plurality of protrusions formed on two opposite sides, and a first case for receiving the flat panel display module. The first case includes a receiving portion for providing a predetermined space in which the flat panel display module is seated, a fixing portion for fixing an end of the flat panel display module, and a plurality of coupling portions to be coupled with the plurality of protrusions. The fixing portion is made of an elastic member.

The fixing portion may include a spring member.

Each of the coupling portions may include a body, and a groove formed in a surface of the body, wherein each groove receives a respective protrusion.

The groove, for example, includes a first groove formed in the surface of the body in a first direction, and a second groove formed in the surface of the body in a second direction crossing the first direction, the first and second grooves being connected to each other.

The first groove, for example, has a shape and a width corresponding to those of the protrusion, and the second groove has a height corresponding to a thickness of the protrusion.

The receiving portion may include a base plate.

The plurality of coupling portions are, for example, arranged on opposite first and second sides of a peripheral portion of the receiving portion.

The plurality of protrusions of the flat panel display module are formed at positions corresponding to the plurality of coupling portions.

The fixing portion can be arranged on a third side of the base plate adjacent to the first and second sides.

The groove of each coupling portion arranged on the first side faces the second side, and the groove of each coupling portion arranged on the second side faces the first side.

The receiving portion may include a plurality of sidewalls extending perpendicular to the base plate.

The plurality of coupling portions may be arranged on each of two opposite first and second sidewalls of the receiving portion.

The fixing portion can be arranged on a third sidewall of the receiving portion adjacent to the first and second sidewalls.

The flat plate module may include a flat panel display panel for displaying an image, a bottom chassis for receiving the flat panel display panel, and a top chassis for covering an upper portion of the fiat panel display panel.

The protrusions may be formed on two opposite sides of the top chassis

The flat panel display panel may he a liquid crystal display panel, and the flat panel display module may further include a backlight unit for emitting light toward the liquid crystal display panel.

The flat panel display may further comprise a second case arranged over the flat panel display module to cover an upper portion of the flat panel display module.

### BRIEF DESCRIPTION OF THE DRAWINGS

Exemplary embodiments of the present invention can be understood in more detail from the following descriptions taken in conjunction with the accompanying drawings, in which:

FIG. 1 is a schematic exploded perspective view showing a conventional liquid crystal display (LCD);

FIG. 2 is an exploded perspective view showing an LCD according to an embodiment of the present invention;

FIG. 3 is a plane view showing an LCD module of FIG. 2;

FIG. 4 is a schematic perspective view showing a rear case of FIG. 2;

FIG. 5 is a plane view showing a fixing portion of the rear case of FIG. 4 coupled to the LCD module of FIG. 3;

FIGS. 6A to 6C are a perspective view, a plane view and a front view, respectively, showing a coupling portion of the rear case of FIG. 4;

FIGS. 7A to 7C, 8A, 8B, 9A and 9B are views for showing a process of coupling an LCD module to a rear case according to an embodiment of the present invention;

FIG. 10 is an exploded perspective view showing an LCD according to an embodiment of the present invention; and

FIG. 11 is an exploded perspective view showing an LCD module of FIG. 10, according to an embodiment of the present invention.

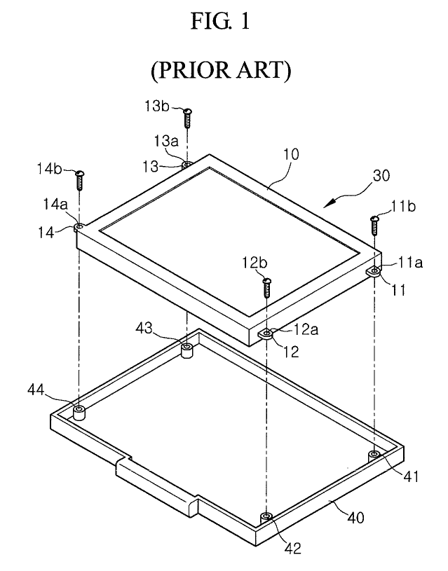

### DETAILED DESCRIPTION OF EXEMPLARY EMBODIMENTS

Exemplary embodiments of the present invention are described more fully hereinafter with reference to the accompanying drawings. This invention may, however, be embodied in many different forms and should not be construed as limited to the exemplary embodiments set forth herein.

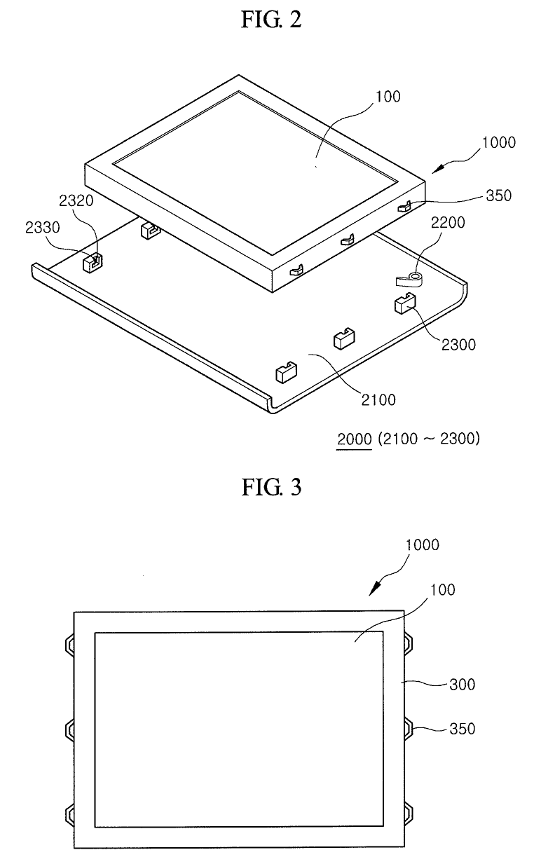

FIG. 2 is an exploded perspective view showing an LCD according to an embodiment of the present invention.

Referring to FIG. 2, the LCD includes an LCD module 1000 and a rear case 2000 for receiving the LCD module.

The LCD module includes an LCD panel 100 for displaying an image. Depending on the type of LCD, the LCD module may also include a backlight unit (not shown) for emitting light to the LCD panel, and a mold frame (not shown) for receiving the LCD panel 100 and the backlight unit. The LCD module also includes a top chassis 300 for covering the LCD panel. A plurality of protrusions 350 are formed on two opposite sides of the top chassis 300, and spaced apart from each other by a predetermined interval.

The rear case 2000 includes a receiving portion 2100 on which the LCD module 1000 is seated, fixing portions 2200 for fixing an end of the LCD module 1000, and a plurality of coupling portions 2300, which are coupled with the plurality of protrusions 350 formed on the fop chassis 300. The receiving portion 2100 is formed in a substantially rectangular plate shape, and the fixing portions 2200 are made of an elastic member such as a spring member having a predetermined elasticity. The spring member used as the fixing portion 2200 may include various kinds of springs such as a coil spring, a plate spring and a member comprising a rubber.

Grooves 2320 and 2330 of a predetermined shape are formed in each coupling portion 2300, and the protrusions 350 are received by and positioned in the grooves 2320 and 2330.

FIG. 3 is a plane view showing the LCD module of FIG. 2.

Referring to FIG. 3, three of the protrusions 350 are formed on each of two opposite sides, e.g., on each of the left and right sidewalls, of the top chassis 300 to be spaced apart from each other by a predetermined interval. Each protrusion 350 may be formed in a substantially trapezoidal shape with a hollow or a ring configuration. The number and shape of the protrusions are not limited to those shown in FIG. 3, and may vary. For example, less or more than three protrusions may be formed on each of the two opposite sides of the top chassis 300, and each protrusion may be formed in any one of a variety of shapes such as square, rectangular and semicircular shapes. In addition, the protrusions 350 are formed integrally with the top chassis 300, but are not limited thereto.

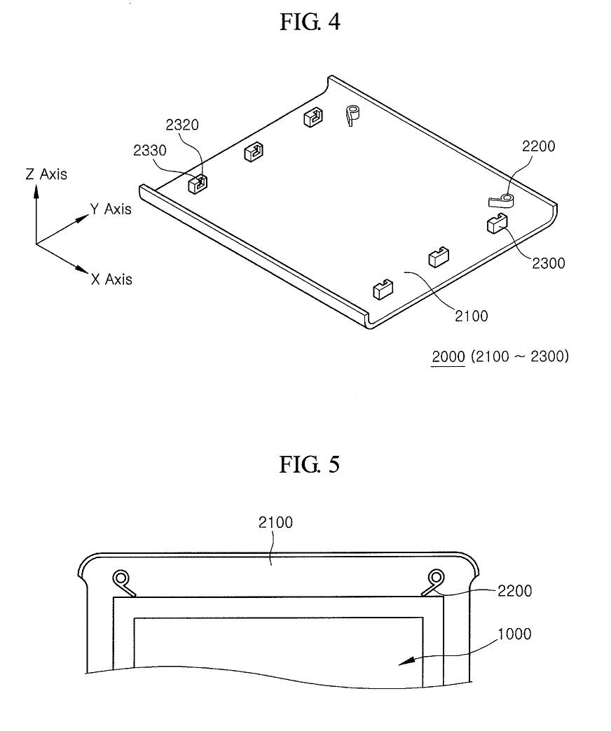

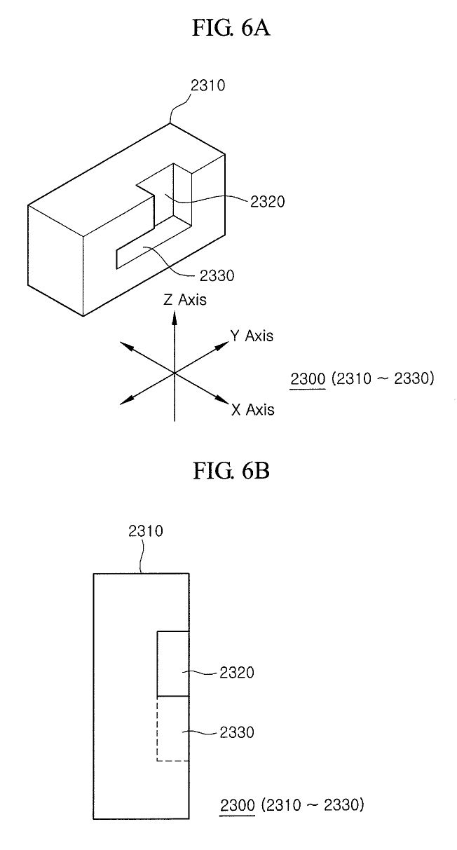

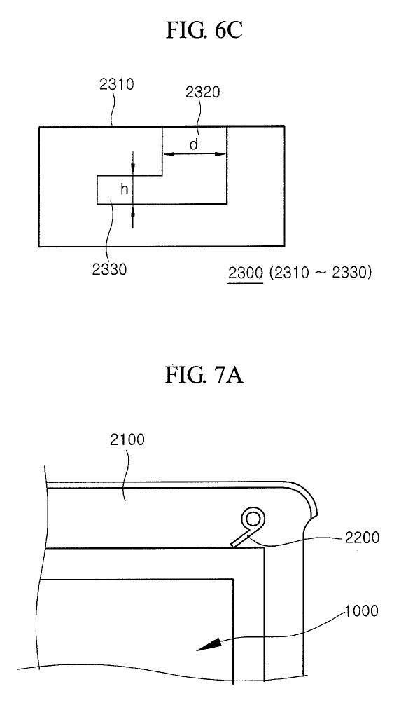

FIG. 4 is a schematic perspective view showing a rear case of FIG. 2. FIG. 5 is a plane view showing a fixing portion of the rear case of FIG. 4 coupled to the LCD module of FIG. 3. FIGS. 6A to 6C are a perspective view, a plane view and a front view, respectively, showing a coupling portion of the rear case of FIG. 4.

Referring to FIGS. 4 and 5, the receiving portion 2100 is formed in a rectangular plate shape and may have a size greater than the LCD module 1000.

Three of the coupling portions 2300 are arranged on each of opposite first and second sides, e.g., on the left and right sides, of the peripheral portion of the receiving portion 2100 to be spaced apart from each other at a predetermined interval. The number and positions of the coupling portions 2300 are formed to correspond to those of the protrusions 350 formed on the top chassis 300 of the LCD module. The grooves 2320 and 2330 of a predetermined shape are formed in each coupling portion 2300, wherein the grooves 2320 and 2330 arranged on the first side face the second side, and the grooves 2320 and 2330 arranged on the second side face the first side. That is, the grooves 2320 and 2330 formed in each coupling portion 2300 face the inside of the receiving portion.

The fixing portions 2200 are arranged on a third side, for example, an upper side of the receiving portion 2100 adjacent to the first and second sides. The fixing portions 2200 are arranged on two ends of the upper side of the receiving portion 2100, for example, left and right ends, respectively. The fixing portion 2200 is made of au elastic member, such as a spring member, as mentioned above, to provide an elastic force in the -y axis direction. The elastic force of the fixing portion 2200 is exerted to an end of the LCD module 1000 in the -y axis direction, thereby serving to prevent the LCD module from being moved upward and to enhance a coupling force between the protrusion 350 and the coupling portion 2300.

Although the spring members used as the fixing portions 2200 are two plate springs, each of which has a general ‘9’ shape, the number, kind and shape of the springs are not limited thereto and may be variously changed.

Referring to FIGS. 6 A to 6C, each coupling portion 2300 includes a body 2310 and the grooves 2320 and 2330 formed in a surface of the body and having a predetermined shape to be coupled with each protrusion 350 of the top chassis 300 (see FIG. 3). The grooves include the first groove 2320 formed in the surface of the body 2310, and extending in a first direction, i.e., in the z axis direction, and the second groove 2330 formed in the surface of the body 2310, and extending in a second direction, i.e., the y axis direction, crossing the first direction. The first groove 2320 and the second groove 2330 are connected to each other.

In addition, the first groove 2320, for example, has the shape and a width d corresponding to the shape and width of the protrusion 350 and the second groove 2330 has the height h corresponding to a thickness of the protrusion 350. The protrusion 350 is inserted into the first groove 2320 of the coupling portion 2300 and then moved and positioned in the second groove 2330. Although each groove is formed in the surface of the body in this embodiment, the present invention is not limited thereto and alternatively, the groove may be in the form of an opening bored through the body.

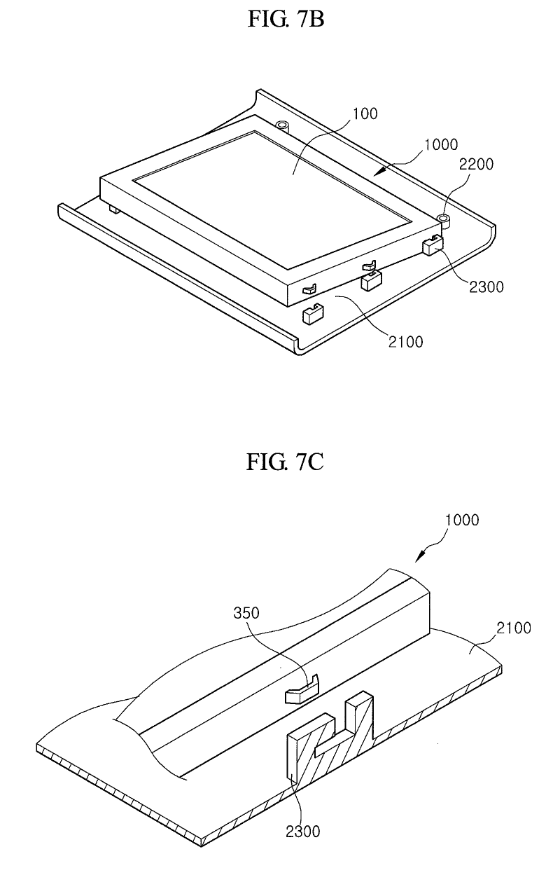

FIGS. 7A to 7C, 8A, 8B, 9A and 9B are views for showing a process of coupling the LCD module to the rear case.

FIGS. 7A to 7C show states before the LCD module 1000 is coupled to the rear case 2000. Referring to FIGS. 7A and 7B, the LCD module 1000 is arranged so that an end thereof contacts the fixing portions 2200 disposed on the receiving portion 2100. At this time, the end of the LCD module 1000 is in contact with the fixing portions 2200, and the other end thereof is spaced apart from the receiving portion 2100 by a predetermined distance. Referring to FIG. 7C, each of the protrusions 350 of the LCD module is not yet in contact with the first or second grooves 2320, 2330.

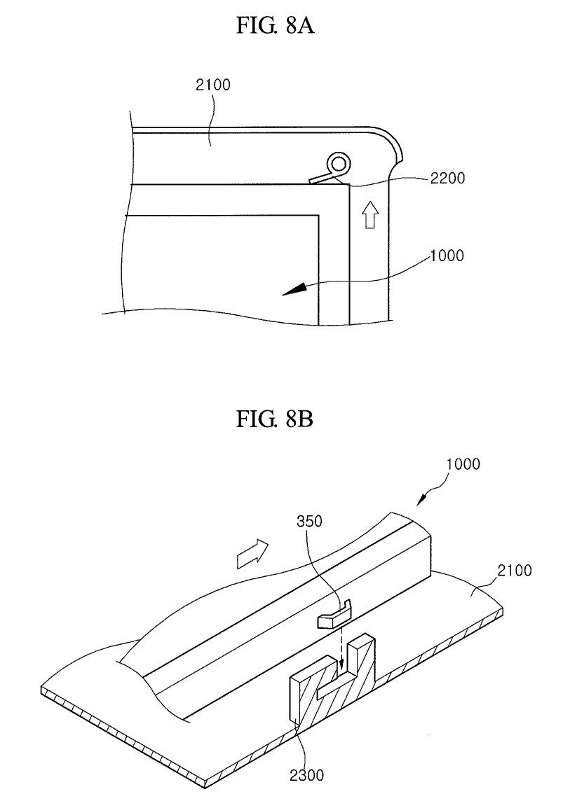

FIGS. 8A and 8B show a state where an external force is applied to the LCD module 1000 in a predetermined direction. Referring to FIG. 8A, if an external force is applied to move the LCD module 1000 upward (as shown by the clear arrow in FIGS. 8A and 8B), ends of the fixing portions 2200 in contact with the end of the LCD module 1000 are bent and moved upward.

Referring to FIG. 8B, while the LCD module is moved upward, the protrusions 350 are also moved upward. As a result, the protrusions 350 are positioned above the first grooves 2320 of the coupling portions 2300 and then inserted into the first grooves 2320 (as shown by the dotted arrow in FIG. 8B).

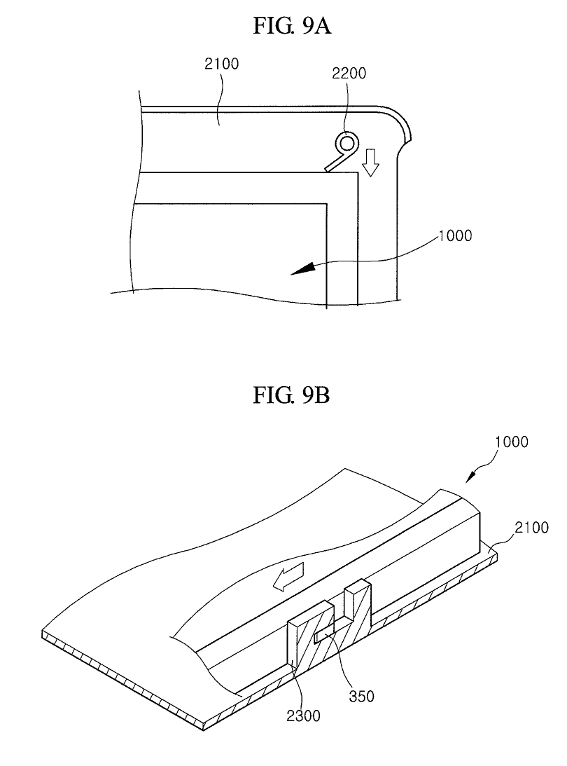

FIGS. 9A and 9B show the state where the protrusion of the LCD module is coupled to the coupling portion of the rear case.

Referring to FIG. 9A, if the external force applied to the LCD module 1000 in the predetermined direction is removed, the fixing portions 2200 are restored to their original state by their elastic force, and the elastic force moves the LCD module in the direction of the clear arrow.

Referring to FIG. 9B, while the LCD module 1000 is moved to in the direction of the clear arrow, i.e., downward, by means of the elastic force of the fixing portions 2200, the protrusions 350 inserted into the first grooves 2320 are also moved downward. As a result, the protrusions 350 are inserted into and coupled to the second grooves 2330 of the coupling portions 2300.

Using such a coupling structure, the LCD module 1000 is securely fixed to the rear case 2000 in horizontal and vertical directions. That is, the LCD module is restrained in the horizontal direction, i.e., in the x axis direction, between the coupling portions 2300 installed at two sides of the rear case according to the size of the LCD module. The profusions are fastened to the second grooves 2330 provided in the coupling portions. The second grooves 2330 correspond to the level of the protrusions of the LCD module, so that the LCD module is also restrained in the vertical direction, i.e., in the z axis direction. In addition, the elastic fixing portions 2200 restrain the LCD module in the y axis direction.

A process of disassembling the LCD module from the rear case 2000 can be performed in an order reverse to the coupling process.

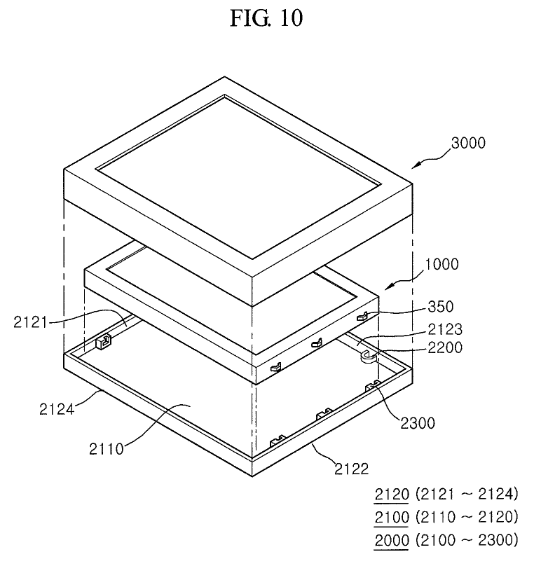

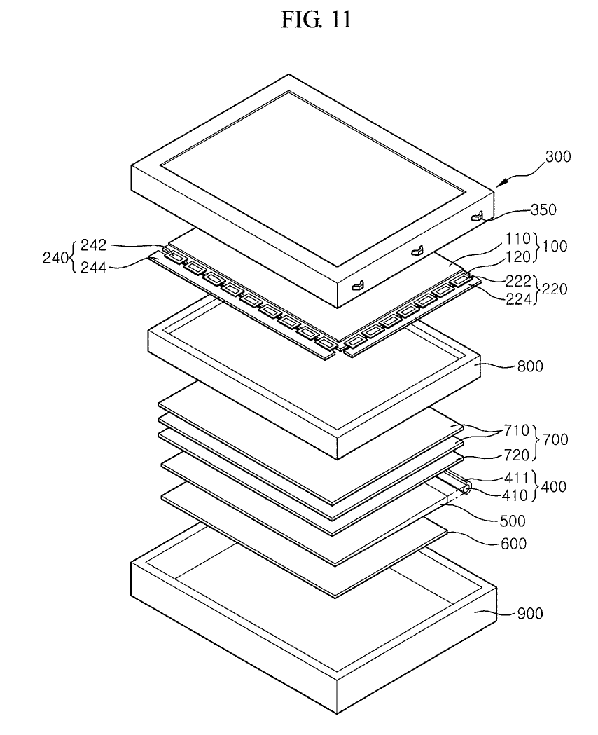

FIG. 10 is an exploded perspective view showing an LCD according to an embodiment of the present invention, and FIG. 11 is an exploded perspective view showing an LCD module of FIG 10. The embodiment shown in FIG. 10 is substantially similar to the embodiment described in connection with FIGS. 2-9B, except with respect to, for example, a structure of a receiving portion of the rear case and an arrangement of the fixing portions.

Referring to FIG. 10, an LCD includes an LCD module 1000, a rear case 2000 for receiving the LCD module, and a front case 3000 for covering the LCD module.

The LCD module 1000 includes an LCD panel 100, and may include a backlight unit. The LCD module includes a top chassis 300 for covering the LCD panel. A plurality of protrusions 350 are formed on each of two opposite sides of the top chassis 300 and spaced apart from each other at a predetermined interval.

The rear case 2000 includes a receiving portion 2100 for providing a predetermined space in which the LCD module 1000 will be placed, fixing portions 2200 for fixing an end of the LCD module 1000, and a plurality of coupling portions 2300 coupled with the plurality of protrusions 350 formed on the top chassis 300. The receiving portion 2100 includes a base plate 2110 having a generally rectangular shape, and a plurality of sidewalks 2120 vertically extending from the base plate 2110.

Three coupling portions 2300 are arranged on each of opposite first and second sidewalls 2121 and 2122 among the plurality of sidewalls 2120. The coupling portions 2300 are spaced apart from each other by a predetermined interval. The number and positions of the coupling portions 2300 are formed to correspond with those of the protrusions 350 formed on the top chassis 300 of the LCD module. At The coupling portion 2300 may be formed integrally with the sidewalls 2121 and 2122 of the rear case 2000, whereby the sidewalls 2121 or 2122 form the body of the coupling portion 2300.

The fixing portions 2200 are arranged on a third sidewall 2123 adjacent to the first and second sidewalls 2121 and 2122, which is opposite a fourth sidewall 2124. The fixing portions 2200 are respectively arranged on both ends, for example, the right and left ends, of the third sidewall 2123. Spring members are used as the fixing portions 2200, for example, two plate springs, each of which has a substantially semicircular shape. The number, kind and shape of the springs are not limited thereto.

Referring to FIG. 11, the LCD module 1000 includes a top chassis 300, an LCD panel 100, driving circuit units 220 and 240, a plurality of optical sheets 700, a lamp unit 400, a light guide plate 500, a reflection plate 600, a mold frame 800 and a bottom chassis 900.

A predetermined receiving space is defined in the mold frame 800. The plurality of optical sheets 700, the lamp unit 400, the light guide plate 500 and the reflection plate 600, which are components of a backlight unit, are arranged in the receiving space of the mold frame. The LCD panel 100 for displaying an image is arranged over the backlight unit.

The driving circuit units 220 and 240 are connected to the LCD panel 100, and include a gate-side printed circuit board (PCB) 224 having a control integrated circuit (IC) mounted thereon and applying a predetermined gate signal to gate lines of a TFT substrate 120, a data-side PCB 244 having a control IC mounted thereon and applying a predetermined data signal to data lines of the TFT substrate 120, a gate-side flexible PCB 222 for connecting the TFT substrate 120 to the gate-side PCB 224, and a data-side flexible PCB 242 for connecting the TFT substrate 120 to the data-side PCB 244. The gate-side and data-side PCBs 224 and 244 are respectively connected to the gate-side and data-side flexible PCBs 222 and 242 in order to apply gate driving and external image signals. The gate-side and data-side PCBs 224 and 244 may be integrated into a single PCB. In addition, driving ICs (not shown) are mounted on the flexible PCBs 222 and 242 to transmit power and RGB (Red, Green and Blue) signals generated in the PCBs 224 and 244 to the LCD panel 100.

The lamp unit 400 includes a lamp 410 and a lamp clamp 411. The lamp 410 may include a cold cathode fluorescent lamp. In addition, the lamp 410 may have an ‘I’ shape as shown in the figure, but it is not limited thereto. The lamp clamp 411, which holds the lamp, also functions to reflect the light, which is generated from the lamp (e.g., the cold cathode fluorescent lamp) in radial directions, to be emitted in a single direction, thereby maximizing a utilization efficiency of the light. The light guide plate 500 is coupled to the lamp clamp 411 to change the light with an optical distribution in the form of a linear light source generated from the lamp unit 400, into the light with an optical distribution in form of a surface light source. A wedge type or a parallel fiat type plate, for example, may be used as the light guide plate 500. Also, as the reflection plate 600, a plate with a high light reflectivity is used. The reflection plate 600 contacts a floor surface of the bottom chassis 900. The reflection plate 600 may be excluded if a material with a sufficient light reflectivity is applied on the floor surface of the bottom chassis 900. The plurality of optical sheets 700 are arranged over the light guide plate 500 to enhance brightness uniformity of the light output from the light guide plate 500.

The top chassis 300 is coupled to the mold frame 800 to cover an edge portion of the LCD panel 100, i.e., to cover a non-displaying region and portions of side and bottom surfaces of the mold frame 800.

A plurality of protrusions 350 are formed on each of two opposite sidewalls of the top chassis 300. The protrusions 350 are spaced apart from each other at a predetermined interval. Such protrusions may be formed integrally with the top chassis. The bottom chassis 900 is mounted below the mold frame 800 to close the receiving space of the mold frame.

Although the aforementioned embodiments have been described based on an LCD among flat panel displays, a flat panel display provided with a coupling structure for coupling a flat panel display module and a case according to the embodiments of the present invention is not limited to an LCD. For example, the coupling structure may be applied to various kinds of flat panel displays such as an organic light emitting diode (OLED) using a principle (referred to as “electroluminescence”) in which when a light emitting material made of an organic material or conjugated polymer with a semiconductor property is interposed between two electrodes and a voltage is then applied thereto, light is generated from the organic material or polymer while a current flows into the light emitting material, or a plasma display panel (PDP) in which a plurality of small cells are arranged between two substrates and gas (e.g., neon or argon) discharge is generated between (positive and negative) electrodes above and below the substrates and then the cells cause self luminescence by means of ultraviolet rays generated by the gas discharge, thereby reproducing color images. According to the embodiments of the present invention, the number of processes of assembling an LCD can be decreased by excluding the use of screws, and the number of parts used for coupling an LCD module to a case is also decreased. As a result, the manufacturing cost is effectively reduced. In addition, it is possible to maintain an LCD with a thin profile.

Although illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A flat panel display, comprising:
a flat panel display module having a plurality of protrusions formed on two opposite sides;
a first ease for receiving the flat panel display module; and
a fixing portion fixing an end of the flat panel display module,
wherein the first case includes a receiving portion providing a predetermined space in which the fiat panel display module is disposed, and a plurality of coupling portions to he coupled with the plurality of protrusions, and
wherein the fixing portion includes an elastic member.

2. The flat panel display as claimed in claim 1, wherein the fixing portion includes a spring member.

3. The flat panel display as claimed in claim 1, wherein each of the coupling portions includes a body, and a groove formed in a surface of the body, wherein each groove receives a respective protrusion.

4. The flat panel display as claimed in claim 3, wherein the groove includes a first groove formed in the surface of the body in a first direction, and a second groove formed in the surface of the body in a second direction crossing the first direction, the first and second grooves being connected to each other.

5. The flat panel display as claimed in claim 4, wherein the first groove has a shape and a width corresponding to a shape and a width of a protrusion, and the second groove has a height corresponding to a thickness of the protrusion.

6. The flat panel display as claimed in claim 4, wherein the protrusions are inserted into the first groove, and then are slid in the second direction to be inserted into the second groove.

7. The flat panel display as claimed in claim 6, wherein the fixing portion slide the flat panel display module in a direction substantially equal to the second direction.

8. The fiat panel display as claimed in claim 3, wherein the receiving portion includes a base plate.

9. The flat panel display as claimed in claim 8, wherein the plurality of coupling portions are arranged on first and second sides of a peripheral portion of the receiving portion.

10. The flat panel display as claimed in claim 9, wherein the plurality of protrusions are formed at positions corresponding to positions of the plurality of coupling portions.

11. The flat panel display as claimed in claim 9, wherein the fixing portion is arranged on a third side of the base plate adjacent to the first and second sides.

12. The flat panel display as claimed in claim 9, wherein the groove of each coupling portion arranged on the first side faces the second side, and the groove of each coupling portion arranged on the second side faces the first side.

13. The flat panel display as claimed in claim 8, wherein the receiving portion further includes a plurality of sidewalls extending perpendicular to the base plate.

14. The flat panel display as claimed in claim 13, wherein the plurality of coupling portions are arranged on each of opposite first and second sidewalls of the plurality of sidewalls.

15. The flat panel display as claimed in claim 14, wherein the fixing portion is arranged on the third sidewall of the plurality of sidewalls adjacent to the first and second sidewalls.

16. The flat panel display as claimed in claim 1, wherein the flat plate module includes a flat panel display panel for displaying an image, a bottom chassis for receiving the flat panel display panel, and a top chassis for covering a portion of the flat panel display panel.

17. The flat panel display as claimed in claim 16, wherein the protrusions are formed on two opposite sides of the top chassis.

18. The flat panel display as claimed in claim 16, wherein the flat panel display panel is a liquid crystal display panel and the fiat panel display module further includes a backlight unit.

19. The flat panel display as claimed in claim 1, further comprising a second case arranged over the flat panel display module to cover a portion of the flat panel display module.
